(19) United States
(12) Patent Application Publication
(10) Pub. No.: US 2017/0237941 A1
(43) Pub. Date: Aug. 17, 2017

(54) REALISTIC VIEWING AND INTERACTION WITH REMOTE OBJECTS OR PERSONS DURING TELEPRESENCE VIDEOCONFERENCING

(71) Applicant: NITIN VATS, Meerut (IN)

(72) Inventor: NITIN VATS, Meerut (IN)

(73) Assignee: NITIN VATS, Meerut (IN)

(21) Appl. No.: 15/503,770

(22) PCT Filed: Aug. 14, 2015
(86) PCT No.: PCT/IN2015/000323

§ 371 Date: Feb. 14, 2017

(30) Foreign Application Priority Data
Aug. 14, 2014 (IN) 427/DEL/2014

(51) Int. Cl. H04N 7/15; G06T 19/00; H04N 5/262; H04N 5/272; H04N 5/265

(52) U.S. Cl. CPC H04N 7/157; H04N 5/272; H04N 5/265; H04N 5/2628; G06T 19/006; G06T 2219/024

(57) ABSTRACT

A method for videoconferencing includes steps of:
receiving audio and video frames of multiple locations having at least one person at each location;—processing the video frames received from all the location except a base location, wherein processing the video frames to extract the person/s by removing background from the video frames of the location;
merging the processed video frames with the base video to generate a merged video, so that the merged video give an impression of co-presence of the persons from all location at the location of the base video; and
displaying the merged video.

### FIELD OF INVENTION

The present invention relates generally to the field of video conferencing, particularly to a method and system for realistic viewing and interaction with remote objects or persons during tele-presence videoconferencing.

### BACKGROUND OF THE INVENTION

Videoconferencing systems have been widely used now-a-days for remote communication primarily to emulate sense of face-to-face discussions. Most videoconferencing systems are costly, require special lighting, or dedicated rooms for installation. Known techniques of special lighting and/or Chroma keying for masking background of video could only partially increase on-screen visualization. In reality or real conference, all participants or people are seated in one room with a user. Currently, in videoconferencing systems, video of participants are shown through display screen depicting people being seated in their individual room or surroundings which do not provide the feeling of reality such as shown in FIG. 1, where a prior art system is shown where two separate videos are displayed on a computer monitor during videoconferencing.

Attempts have been made to increase realism, but unfortunately viewing and interaction with remote objects or persons/participants during videoconferencing is not realistic. For example users taking part in videoconferencing cannot interact with each participant in realistic manner such as shaking hands with each other, visualize sitting near remote user,and visualize placing of arms around remote users shoulder as done in reality when people meet physically. This system allow us to get this enriched feeling of video conferencing.

Therefore, there is a need to provide a simplified and cost-effective system for enriched user engagement and realistic interaction experience during telepresense videoconferencing such that real-time direct user-to-user interactions are made possible. For example talking to the remote user by visualizing sitting next to him, where during speaking or performing hand and/or body movements before a camera, the performed action can be reflected in the video of remote user in real-time without any noticeable delay in video display.

Additionally, attempts have been made to use special kind of display screen or arrangement to show a perception of depth in video during videoconferencing. However, unfortunately current technology and systems still show people at remote locations seated at their individual environment or rooms. In reality or real conference, all participants or people are seated in one room with a user, whereas in present videoconferencing systems video of participants are shown through display screen depicting people being seated in their individual room or surroundings which do not provide the feeling of reality.

Therefore, it is a need of the time that remotely seated user/participant during a videoconference should appear as if being seated or located in same room of another user/participant for realistic telepresence and visualization experience.

The object of the invention is to provide more realistic conferencing between remotely located people to provide a feel of realistic conferencing in physical world.

### BRIEF DESCRIPTION OF THE DRAWINGS

FIG. 1 illustrates a videoconferencing system is illustrated depicting display of video in existing systems in two remote locations connected via a network.

FIG. 2(a)-(c) illustrates, different views of realistic visualization and interaction with two remote participants sitting at first location and a user sitting at second location during telepresence videoconferencing in one example.

1.

FIG. 3 illustrates another example of realistic visualization and interaction with the two remote participants sitting at first location and the user sitting at second location during telepresence videoconferencing of FIG. 3

FIG. 4 illustrates different realistic visualization experience during telepresence videoconferencing between two participants seated at remote locations with a transparent electronic visual display depicted in a portion of a room.

FIG. 5 illustrates realistic visualization experience during telepresence videoconferencing among multiple participants seated at remote locations with a transparent electronic visual display.

### SUMMARY

The object of the invention is achieved by methods of claims 1 and 18, system of claims 9 and 26, and computer program products of claims 17 and 34

According to one embodiment of the method, the method includes steps of:
receiving audio and video frames of multiple locations having at least one person at each location;
processing the video frames received from all the location except a base location, wherein processing the video frames to extract the person/s by removing background from the video frames of the location;
merging the processed video frames with the base video to generate a merged video, so that the merged video give an impression of co-presence of the persons from all location at the location of the base video; and
displaying the merged video.

According to another embodiment of the method, wherein displaying the merged video at all the locations.

According to yet another embodiment of the method, the method includes resizing of the video frames from one or more locations according to distance from camera so that all persons co-present in the merged video appears to be at equal distance from the camera.

According to one embodiment of the method, wherein the extracted persons processed video frames are adapted to be superimposed in the merged video.

According to another embodiment of the method, the method includes following steps:
assigning positions onto a video frame of the base video to the person/s of the processed video frames;
further processing the processed video frames to relocate the person/s according to the assigned position to generate a position processed video frames;
merging the base video and the position processed video frames to generate the merged video.

According to yet another embodiment of the method, the method includes receiving a first user inputs from the person/s of the processed video frames to choose the position onto the video frame from the base video.

According to one embodiment of the method, the method includes changing orientation of a video capturing device for a person according to the assigned position of the person in the base video,

According to another embodiment of the method, the method includes receiving a second user input from the person's present at all the locations to select a base location and determining the video with the base location as base

In one of the implementation of video conferencing, the method steps include:
receiving audio and video frames of multiple locations having at least one person at each location;
processing the video frames received from all the location to extract the person/s by removing background from the video frames of the location;
merging the processed video frames with a base video frames or a base image to generate a merged video, so that the merged video give an impression of co-presence of the persons from all location at the location of the base video or image; and
displaying the merged video.

The merged video is displayed over wearable display or non-wearable display.

The non-wearable display includes electronic visual displays such as LCD, LED, Plasma, OLED, video wall, box shaped display or display made of more than one electronic visual display or projector based or combination thereof, a volumetric display to display the video in three physical dimensions, create 3-D imagery via the emission, scattering, beam splitter or pepper's ghost based transparent inclined display or a one or more-sided transparent display based on peeper's ghost technology.

The wearable display includes head-mounted display, optical head-mounted display which further comprises curved mirror based display or waveguide based display, head mount display for fully 3D viewing of the video by feeding rendering of same view with two slightly different perspectives to make a complete 3D viewing of the video.

### DETAILED DESCRIPTION OF THE DRAWINGS

One or more described implementations provides a system and a method for realistic viewing and interaction with remote objects or persons during tele-presence videoconferencing. The system comprises one or more processors, a video output displaying screen, a camera that captures video of users during videoconferencing, video modification unit, a video alignment and adjusting unit for adjusting the video/image of remote user on video output displaying screen, a location choosing unit, a video displayer that displays video output, and a telecommunication unit that receives and transmits video and audio data in real-time through a network. The network may be an analog or digital telephone network, LAN or Internet. The units may be stored in a non-transitory computer readable storage medium. The video modification unit automatically removes background from video of a remote user during videoconferencing in real-time. In one implementation, the video modification unit prepares background of particular color from video input, where the background can be masked. In another implementation, merging of video stream of remote user/s with removed background with a background video obtained from another user location or receiver system may be carried out by the video modification unit. A mono-color background such as a mono-color chair may be used behind one or more participants. The video output displaying screen is a computer monitor, a transparent electronic visual display screen, a television or a projection. The invention should not be deemed limited to a particular embodiment of the video output displaying screen, and chat any electronic visual display such as LCD, OLED, plasma or the like or holographic display or a display or arrangement showing video in depth may fee used. A sound input device such as microphone is provided for capturing audio. A network interface and camera interface may also be provided.

Background subtraction from live video to extract human from background can be done by different available algorithms. The methods are based on following concepts. The brief is as follows.

Background subtraction is a widely used approach for detecting moving objects in videos from static cameras. The rationale in the approach is that of detecting the moving objects from the difference between the current frame and a reference frame, often called “background image”, or “background model”.

Face can be detected based on the typical skin detection

Another approach to this problem would use a model which describes the appearance, shape, and motion of faces to aid in estimation. This model has a number of parameters (basically, “knobs” of control), some of which describe the shape of the resulting face, and some describe its motion.

Another method for real-time face detection is by edge orientation information. Edge orientation is a powerful local image feature to model objects like faces for detection purposes.

In one aspect of the present invention, a method is provided for realistic viewing and interaction with remote objects or persons during telepresence videoconferencing. The method comprises: capturing video and audio, the video comprising at least one object or user; automatically modifying video in real-time; transmitting video and audio through a network; receiving video and audio through a network; receiving input for realistic interaction to mingle modified video with remote user/s video; merging modified video with remote user/s video in real-time during ongoing receiving and transmission of video and audio during teleconferencing; adjusting video of one or more users in merged video on video output displaying screen; and displaying modified and aligned video in real-time during videoconferencing, where except the step of adjusting the video of remote user, all the above steps—are repeated for sustained videoconferencing. The adjusting video of remote user on video output displaying screen may be automatic or manual.

Transparent display can be fabricated by OLED, AMOLED, which is self-illuminating by passing current. Transparent screen may be made up of film that can be adhered to acrylic or glass cut to shape sheet or may be made by sandwiching the film between support sheets and projector can illuminate the display. The video with transparent background gives realistic video conferencing as if other people/s are just sited in front of each other.

The invention has advantages that it makes possible not only visualization of remote participants in a videoconferencing but also realistic interaction with remote users for enriched and extremely realistic telepresence experience. A user can visualize and get a sense of being present in the remote user's location and interact with the remote user in an enriched and engaging manner without any delay between video signal capture and signal transmission.

The invention can make it possible to virtually form a classroom environment by putting different students all together at different seats in one video. User can virtually sit with friends and can shake hand/hug each other as frames are one over other which gives people to move across whole frame to make possible to touch and greet any one in frame to give realistic virtual interaction with friends.

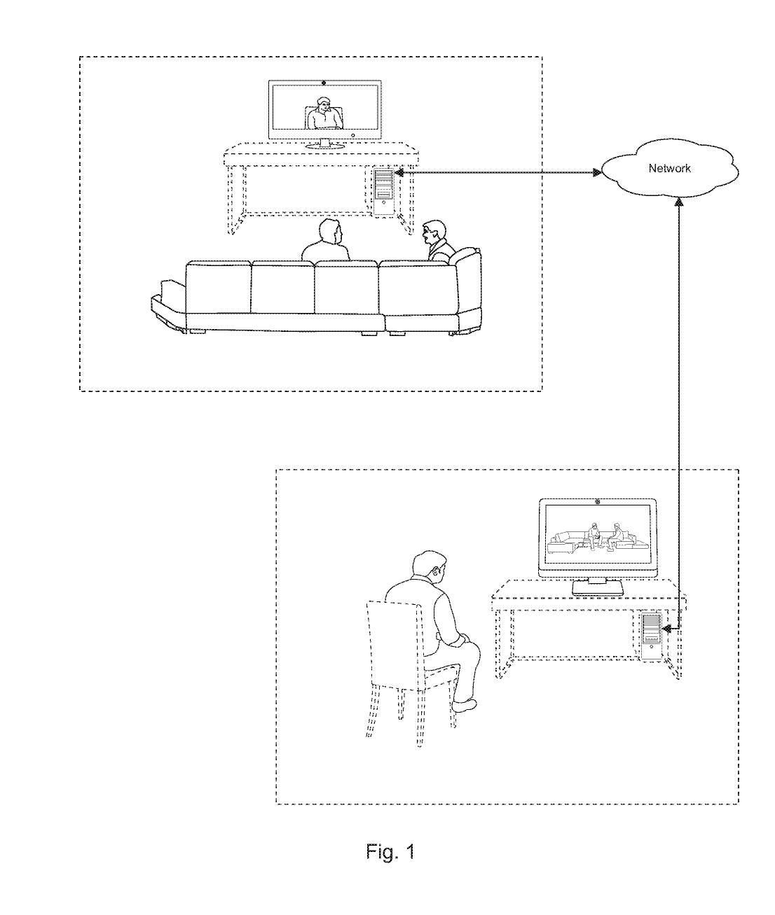

The invention and many advantages of the present invention will be apparent to those skilled in the art by going through the accompanying drawings and a reading of this description taken in conjunction with drawings, in which like reference numerals identify like elements. Referring now to FIG. 1, a videoconferencing system is illustrated depicting display of video in existing systems in two remote locations connected via a network. The user do not have any option to mingle with displayed video for realistic visualization and interaction.

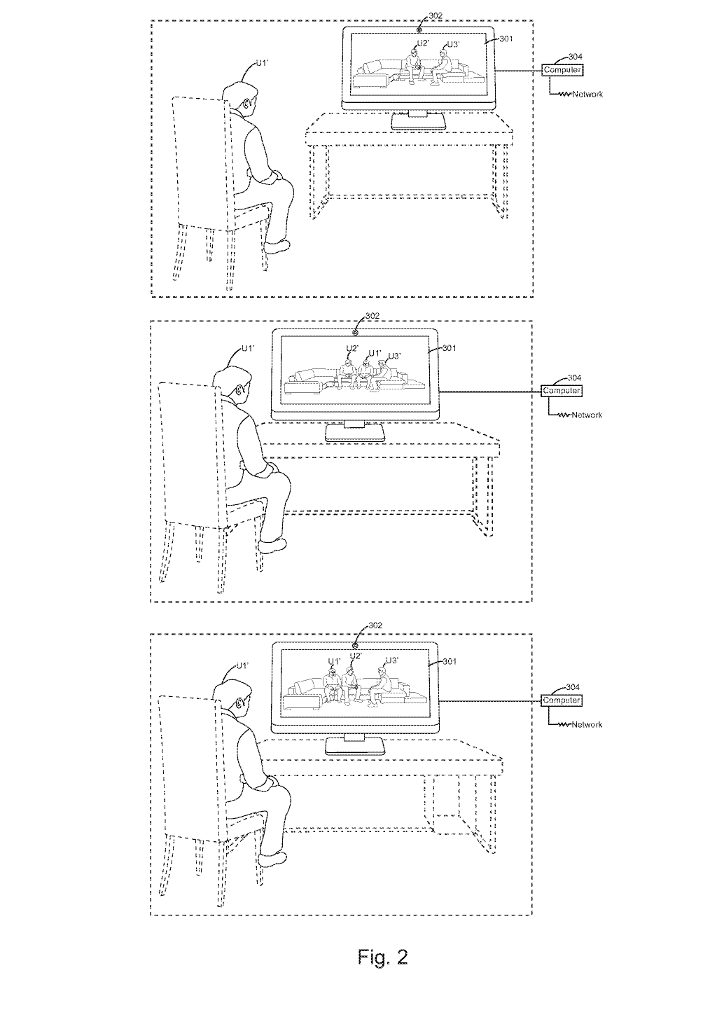

FIG. 2 illustrates, through illustrations (a)-(c) different views of realistic visualization and interaction with two remote participants sitting at first location and a user sitting at second location during telepresence videoconferencing in one example. In illustration (a), a user U1 is shown seated in front of an electronic visual display 301. An electronic visual display 301 is shown displaying video (U2′, U3′) of remote users both seated in a sofa with background scene. A user U1 when provides input for realistic interaction to mingle modified video with remote user/s video (U2′, U3′), a merged video is displayed continually during teleconferencing as shown in illustration (b) of FIG. 2. The merged video comprises modified video of user U1 without background scene and video of (U2′, U3′) with background scene or surroundings of first location. Video of user U1 is captured by a camera 302. The location to be displayed for merged video can be selected using the location choosing unit. The position of the modified video U1′ of user U1 can be adjusted or changed during ongoing videoconferencing using the video alignment and adjusting unit, as shown in illustration (c) of FIG. 2. The adjusting is automatically carried out in first instance and may be adjusted manually also as per user choice. A computer 304 comprising one or more processors and at least a storage medium is coupled to the electronic visual display 301, where the computer is configured to carry out the realistic visualization and interaction during videoconferencing.

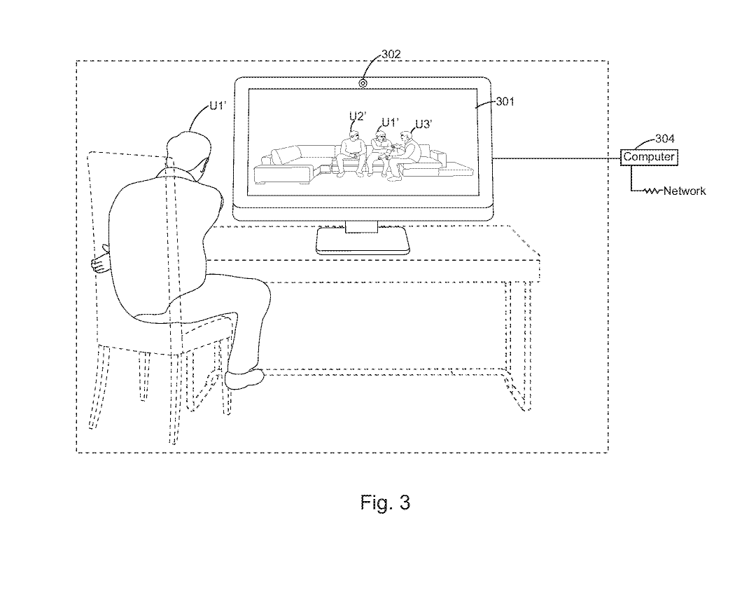

FIG. 3 illustrates another example of realistic visualization and interaction with the two remote participants sitting at first location and the user sitting at second location during telepresence videoconferencing of FIG. 3. The user U1 when moves his before the camera 302 in a position of handshake, the merged video on the electronic visual display 301 displays in real-time interaction with the remote user's video U3′ emulating handshake as in reality.

In one aspect of the present invention, a method is provided for providing realistic visualization experience during telepresence videoconferencing. The method comprises capturing video and audio, the video comprising at least one participant during videoconferencing, transmitting video and audio through a network, automatically modifying video in real-time; and displaying modified video in real-time during videoconferencing. The automatically modifying video may be carried out on video sender system in place of video receiver system. The step of automatically modifying video involves removing background from video of a remote user during videoconferencing in real-time. In one implementation, the step of automatically modifying video may involve preparing background of particular color from video input, where the background can be masked such that only user is displayed without any background. In another implementation, merging of video stream of remote user/s with removed background with a background video obtained from another user location or receiver system may be carried out in the step of automatically modifying video in real-time.

The invention has advantages that it makes possible visualization of remote participants in a videoconferencing through modified video output of participants providing improved illusion of real face-to-face conversation among participants in same place, as if the participants are seated in a same room. An illusion of 3D (three-dimensional) is perceived in the displayed video of remote user over a transparent electronic visual display during videoconferencing. The system doesn't produce noticeable delay between video signal capture and signal transmission and enhances engagement experience between users.

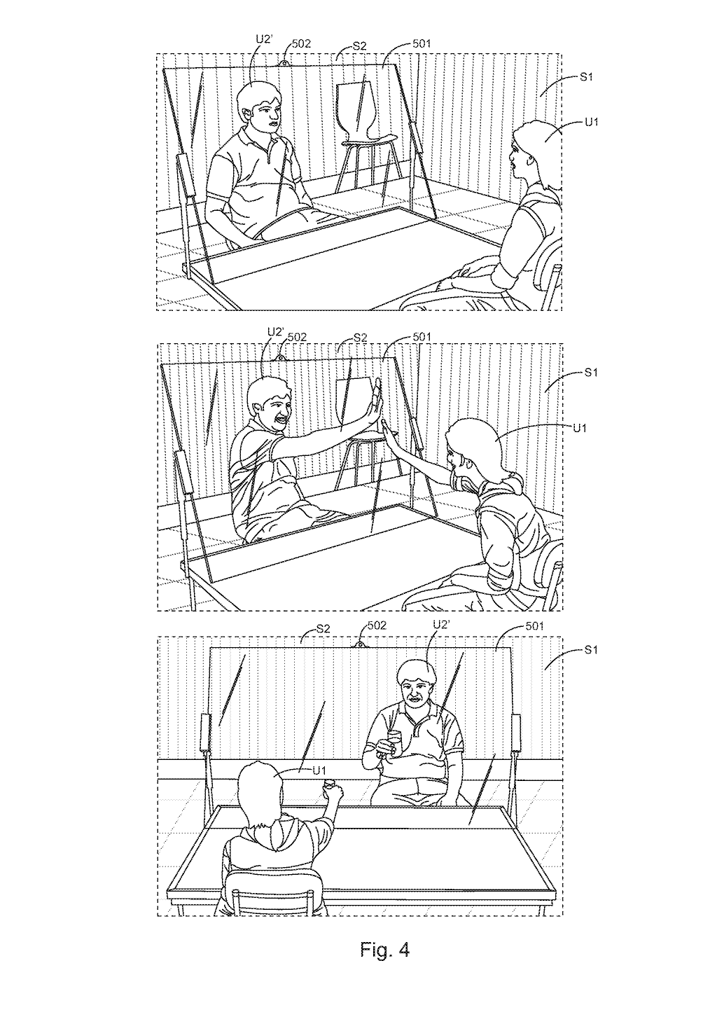

The invention and many advantages of the present invention will be apparent to those skilled in the art by going through the accompanying drawings and a reading of this description taken in conjunction with drawings, in which like reference numerals identify like elements. Referring now to FIG. 4, which shows different realistic visualization experience during telepresence videoconferencing between two participants seated at remote locations with a transparent electronic visual display 501 depicted in a portion of a room. A user U1 is shown seated in front of a transparent electronic visual display 501 in his room with surroundings (s1, s2). A video U2′ of another user/participant, who is in remote location, is displayed on the transparent electronic visual display 501. The video U2′ displayed is a modified video, where background scene or visuals of surroundings of the remote user is automatically and continually removed during videoconferencing. The first user U1 surrounding s2 can be seen behind the modified video U2′ of remote user emulating real face-to-face conversation and interaction between the participants in same place, as if the participants/users are seated in a same room unlike the prior art system as shown in FIG. 1, where users appear sitting in another location on electronic screen without any realistic effect. The remote user is seated in a chair having a mono-colour texture. Having mono-colour background or Chroma background simplifies background removal. However, the present invention should not be deemed limited to using of mono-colour background or Chroma background behind user during teleconferencing, as the video modification unit is capable of removing background without Chroma or mono-colored background.

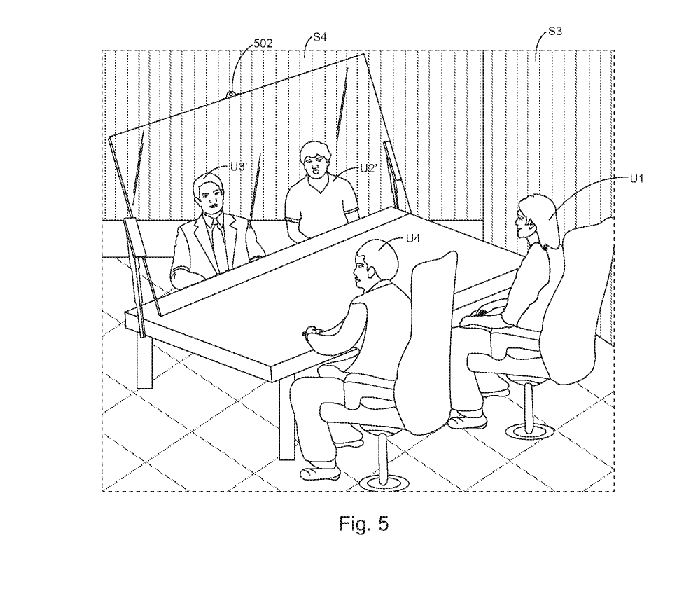

FIG. 5 illustrates realistic visualization experience during telepresence videoconferencing among multiple participants seated at remote locations with a transparent electronic visual display 501. Two users (U1, U4) are shown seated in front of a transparent electronic visual display 501 in same room with surroundings (s3, s4). Modified video (U2′, U3′) of two users, each seated at different remote locations is displayed on the transparent electronic visual display 501. Video of remote users is captured by a camera, and transmitted through a network. The captured original video of remote users is automatically modified, where background scene or surrounding other than user from video of each remote user is removed in real-time. The modified video of different remote users is showing in real-time during videoconferencing on the transparent electronic visual display 501. The automatically modifying video may be carried out on video sender system in place of video receiver system.

While the invention is susceptible to various modifications and alternative forms, specific embodiments thereof have been shown by way of example in the drawings and are herein described in detail.

1-17. (canceled)

18. A method for video conferencing:
receiving audio and video frames of multiple locations having a least one person at each location;
processing the video frames received from all the location to extract the person/s by removing background from the video frames of the location;
merging the processed video frames with a base video frames or a base image to generate a merged video, so that the merged video give an impression of co-presence of the persons from all location at the location of the base video or image; and
displaying the merged video.

19. The method according to claim 18, displaying the merged video at all the locations.

20. The method according to the claim 18 comprising
resizing of the video frames from one or more locations according to distance from camera so that all persons co-present in the merged video appears to be at equal distance from the camera.

21. The method according to the claim 18, wherein the extracted persons in the processed video frames are adapted to be superimposed in the merged video.

22. The method to the claim 18 comprising:
assigning positions onto a video frame of the base video or the base image to the person/s of the processed video frames;
further processing the processed video frames to relocate the person/s according to the assigned position to generate a position processed video frames;
merging the base video or the base image with the position processed video frames to generate the merged video.

23. The method according to claim 22 comprising:
receiving a first user inputs from the person/s of the processed video frames to choose the position onto the base image or video frame from the base video.

24. The method according to the claim 22 comprising:
changing orientation of a video capturing device for a person according to the assigned position of the person in the base image or the base video.

25. The method according to the claim 18 comprising:
receiving a second user input from the person/s present at all the locations to select a base location; and
determining the video with the base location as base video.

26. A system for video conferencing comprising:
one or more input devices;
a display device;
one or more video capturing device;
a computer graphics data related to graphics of the 3D model of the object, a texture data related to texture of the 3D model, and/or an audio data related to audio production by the 3D model which is stored in one or more memory units; and
machine-readable instructions that upon execution by one or more processors cause the system to carry out operations comprising:
receiving audio and video frames of multiple locations having at least one person at each location;
processing the video frames received from all the location to extract the person/s by removing background from the video frames of the location;
merging the processed video frames with a base video frames or a base image to generate a merged video, so that the merged video give an impression of co-presence of the persons from all location at the location of the base video or image; and
displaying the merged video.

27. The system according to claim 26, wherein the processor is adapted to resize of the video frames from one or more locations according to distance from camera, so that all persons co-present in the merged video appears to be at equal distance from the camera.

28. The system according to the claim 26, wherein the extracted persons in the processed video frames are adapted to be superimposed in the merged video.

29. The system according to the claim 26, wherein the processor is adapted to perform following steps:
assigning positions onto a video frame of the base video to the person/s of the processed video frames;
further processing the processed video frames to relocate the person/s according to the assigned position to generate a position processed video frames;
merging the base video and the position processed video frames to generate the merged video.

30. The system according to claim 29, wherein the processor receives a first user input from the person's of the processed video frames to choose the position onto the video frame from the base video.

31. The system according to the claim 29, wherein the processor is adapted to effectuate automatically or support the person/s in changing orientation of a video capturing device for a person according to the assigned position of the person in the base video.

32. The system according to the claim 26, wherein the processor is adapted to perform the following steps:
receiving a second user input from the person/s present at all the locations to select a base location; and
determining the video with the base location as base video.

33. The system according to the claim 26, wherein video-conferencing is accessible over a web-page via hypertext transfer protocol, or as offline content in stand-alone system or as content in system connected to network through a display device which comprises wearable display or non-wearable display,
Wherein the non-wearable display comprises electronic visual displays such as LCD, LED, Plasma, OLED, video wall, box shaped display or display made of more than one electronic visual display or projector based or combination thereof, a volumetric display to display the video in three physical dimensions, create 3-D imagery via the emission, scattering, beam splitter or pepper's ghost based transparent inclined display or a one or more-sided transparent display based on peeper's ghost technology, and
Wherein wearable display comprises head-mounted display, optical head-mounted display which further comprises curved mirror based display or waveguide based display, head mount display for fully 3D viewing of the video by feeding rendering of same view with two slightly different perspective to make a complete 3D viewing of the video.

34. A computer program product stored on a computer readable medium and adapted to be executed on one or more processors, wherein the computer readable medium and the one or more processors are adapted to be coupled to a communication network interface, the computer program product on execution to enable the one or more processors to perform following steps comprising:
receiving audio and video frames of multiple locations having at least one person at each location;
processing the video frames received from all the location to extract the person/s by removing background from the video frames of the location;
merging the processed video frames with a base video frames or a base image to generate a merged video, so that the merged video give an impression of co-presence of the persons from all location at the location of the base video or image; and
displaying the merged video.
